(19) United States
(12) Patent Application Publication
(10) Pub. No.: US 2026/0022653 A1
(43) Pub. Date: Jan. 22, 2026

(54) CONTROLLABLE COOLANT PUMP WITH ELECTRIC AUXILIARY PUMP

(71) Applicant: Nidec GPM GmbH, Auengrund OT Merbelsrod (DE)

(72) Inventor: Franz PAWELLEK, Lautertal (DE)

(21) Appl. No.: 19/269,631

(22) Filed: Jul. 15, 2025

(30) Foreign Application Priority Data
Jul. 18, 2024 (DE) 10 2024 120 435.4

(51) Int. Cl. F01P 5/12; F01P 7/16; F04D 13/06; F04D 13/12

(52) U.S. Cl. CPC F01P 5/12; F01P 7/16; F04D 13/06; F04D 13/12; F01P 2005/125

(57) ABSTRACT

A controllable coolant pump includes a pump housing, an impeller, a pump shaft rotatably mounted in the pump housing and on free ends of which a belt pulley on one side and the impeller on an opposite side are arranged in a rotationally fixed manner, an annular slider in a pump chamber and biased by a compression spring to control an outflow region of the impeller of the coolant pump, and an electric auxiliary pump to draw coolant from an impeller side chamber and deliver the coolant with increased pressure to a side of the annular slider facing away from the impeller in such a way that the annular slider is displaceable against a force of the compression spring.

### CROSS REFERENCE TO RELATED APPLICATION

The present application claims priority under 35 U.S.C. § 119 to German Application No. 102024120435.4 filed on Jul. 18, 2024, the entire contents of which are incorporated herein by reference.

### BACKGROUND OF THE INVENTION

### 1. Field of the Invention

The present disclosure relates to controllable coolant pumps, commercial vehicles including controllable coolant pumps, and methods for operating controllable coolant pumps.

### 2. Background

It is known to use controllable coolant pumps in commercial vehicles in order to guide the cooling water in a closed circuit through cooling channels of the crankcase and the cylinder head in the combustion engine and then to cool it back into an air-water heat exchanger or radiator.

A coolant pump driven directly by a belt drive is often used for this purpose. Due to a direct coupling between the coolant pump and the crankshaft, the pump speed is dependent on the speed of the combustion engine. As a result, the coolant circulates during a cold start of the combustion engine, which delays the desired rapid heating of the combustion engine and the associated optimum operating temperature. As part of the continuous optimization of combustion engines with regard to emissions and fuel consumption, it is important to bring the engine up to operating temperature as quickly as possible after a cold start and to keep it at the optimum temperature. The water pump should generate just as much volume flow as is required to maintain the optimum temperature. This reduces the intake power of the controlled water pump compared to an uncontrolled pump. This reduces both frictional losses and emissions, as well as fuel consumption. To achieve this effect, controllable coolant pumps are used, whose delivered volume flow can be adjusted to the cooling requirements of the combustion engine.

In the commercial vehicle sector, water pumps with controllable viscous couplings and switchable eddy current couplings are well known. Both concepts are based on a speed change of the impeller.

### SUMMARY

Example embodiments of the present disclosure provide controllable coolant pumps which, compared to known pumps, save fuel, are cost-effective, and satisfy installation space requirements of existing combustion engines.

Example embodiments of the present disclosure provide controllable coolant pumps, commercial vehicles including controllable coolant pumps, and methods for operating controllable coolant pumps.

A controllable coolant pump according to an example embodiment of the present disclosure includes a pump housing, an impeller, a pump shaft rotatably mounted in the pump housing, on free ends of which, on one side, a belt pulley and, on an opposite side, the impeller are arranged in a rotationally fixed manner, and an annular slider in a pump chamber and biased by a compression spring to control an outflow region of the impeller of the coolant pump. The coolant pump also includes an electric auxiliary pump to draw coolant from an impeller side chamber and deliver the coolant with increased pressure to a side of the annular slider facing away from the impeller such that the annular slider is movable against the spring force of the compression spring.

The actuator system can be created with just a few inexpensive components. Large, hydraulically effective surfaces are available as a result of the direct slider impact. The system is robust and durable. The hydraulic force level is preferably so high that the spring force of the compression spring can be high, resulting in a low clamping risk for the slider.

Preferably, a hydraulically effective surface of the annular slider is configured such that a maximum pressure difference of about 0.6 bar or about 0.3 bar, is sufficient to move the annular slider. The auxiliary pump can therefore be particularly cost-effective.

It is advantageous if the annular slider includes an outer cylinder and a circular disk including an opening in the circular disk through which the coolant reaches the suction nozzle of the auxiliary pump. The opening is preferably directly adjacent to the outer cylinder in the radial direction. As a result, the inlet pressure for the auxiliary pump is approximately as high as the pressure reached by the pump stage. Thus, an inexpensive auxiliary pump with a low pressure increase can be used.

Preferably, a tube is pressed into the opening to separate an inlet of the auxiliary pump from a pressure area. A coarse filter can be provided in the tube. Optionally, an inlet dome can also be provided in the housing.

The annular slider is preferably guided during axial movement on a guide sleeve in the pump chamber and the compression spring is supported on the guide sleeve. For low-friction guidance, open guiding tapes can be provided between the guide sleeve and the pump chamber and/or the pump chamber and the outer cylinder. The open guiding tapes do not completely seal the hydraulic chamber. However, the leakage can easily be replaced by the electric centrifugal pump.

It is particularly cost-effective if the auxiliary pump is a centrifugal pump with an uncovered impeller, and a suction channel and a pressure channel are located in the pump housing. It is advantageous if an axis of rotation of the impeller of the auxiliary pump is inclined, in particular, perpendicular or substantially perpendicular to an axis of rotation of the pump shaft.

Furthermore, a commercial vehicle according to an example embodiment of the present disclosure includes a combustion engine, a cooling circuit to cool the combustion engine, and at least one controllable coolant pump according to an example embodiment described above, wherein the coolant pump is configured to transport coolant present in the cooling circuit, and the at least one controllable coolant pump is driven by a crankshaft of the combustion engine via a belt drive.

In addition, a method for operating a controllable coolant pump according to an example embodiment of the present disclosure described above includes measuring an actual temperature in a cooling circuit and determining a temperature difference between an actual temperature and a target temperature, calculating a control current for the auxiliary pump based on the temperature difference via a proportional integral differential controller and pulse width modulation, and controlling the auxiliary pump with the control current.

Using the electric auxiliary pump, it is thus possible to continuously adjust the flow rate of the mechanical coolant pump, regardless of the pump speed.

It is also conceivable to use a displacement sensor to determine the position of the annular slider and to incorporate the position as feedback into the volume flow control circuit. For this purpose, a multi-dimensional performance map can be stored in the engine controller, from which the volume flow can be read out depending on the pump speed of the annular slider position, the temperature of the medium and the thermostat position.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure will be described in more detail below with reference to the drawings. Identical components or components with identical functions have the same reference signs.

FIG. 1 shows a longitudinal section through a controllable coolant pump.

FIG. 2 shows a block diagram describing the control of the controllable coolant pump.

### DETAILED DESCRIPTION

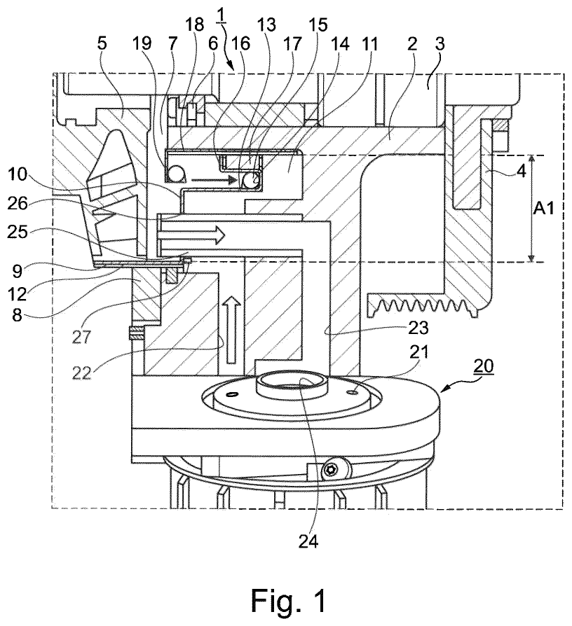

FIG. 1 shows a portion of a controllable coolant pump 1. The coolant pump 1 includes a pump housing 2 in which the pump shaft 3 is freely rotatably mounted. A belt pulley 4 is arranged on one of the two free ends of the pump shaft 3 in a rotationally fixed manner outside the pump housing 2. A traction portion of the traction drive, which is preferably a belt drive, connects the belt pulley 4 to a crankshaft of a combustion engine, not shown. An impeller 5 is pressed onto the opposite free end of the pump shaft 3 inside the pump housing 2. The speed of the impeller 5 is therefore determined by the speed of the pulley 4. On the impeller side, a sealing device 6 is provided on the pump shaft 3, which separates the coolant-carrying area from the dry area. When the impeller 5 is rotating in the operating state of the coolant pump 1, the coolant 7 flows axially via a suction connection (not shown) to the impeller 5 and is directed radially into a pressure channel 8 or spiral channel (not shown). A pump cover connected to the impeller 5 provides a transition between the suction connection and the pressure channel 8. An annular slider 9 is provided to influence the discharge volume of the coolant pump 1. The annular slider 9 includes a circular disk 10, which sits in a circular and concentric pump chamber 11 surrounding the pump shaft 3 in the pump housing 2. The circumference of the circular disk 10 is adjoined by an outer cylinder 12, the inner diameter of which slightly protrudes beyond the outer diameter of the impeller 5. On the inside, an inner cylinder 13 adjoins the circular disk 10, which extends in the opposite axial direction to the outer cylinder 12 and has a contour on the inside with a spring seat 14 to accommodate a spring 15 and a folded edge 16 on the circumferential side to accommodate an open guiding tape 17. The guiding tapes 17 enable low-friction radial guidance of the annular slider 9 along a guide sleeve 18, which sits on the inside of the pump chamber 7. The guide sleeve 18 includes an edge 19 at the impeller-side end, which allows the spring 15 to be supported. The spring 15 is a compression spring that presses the annular slider 9 away from the impeller 5 and holds it in an open position (fail-safe). The outside of the outer cylinder 12 is also guided axially in the pump housing with low friction by an open guiding tape. The impact points of the guiding tape on the annular slider 9 act as discharge throttles, via which the hydraulic volume displaced during the return stroke of the annular slider 9 moves back to the side of the annular slider 9 close to the impeller. The annular slider 9 is a deep-drawn structure, for example.

An auxiliary electric pump 20, such as a centrifugal pump, is integrated into the coolant pump 1. The electric auxiliary pump 20 includes an uncovered impeller 21 and therefore does not have its own volute cover. A pump volute is not required due to the small flow rate. A concentric annular guide device is sufficient. The inlet and outlet of the auxiliary pump 20 are defined by the geometry of the pump housing 2 of the coolant pump 1. The pump housing 2 includes a pressure channel 22, which extends from a radially outer area of the impeller 5 of the electric coolant pump to the pump chamber 11, and a suction channel 23, which extends from a suction nozzle 24 of the auxiliary pump 20 on the impeller 21 to the pump chamber 11. The connection to the rear of the annular slider 9 is established from the annular guide device via a bore.

The inlets and outlets of the two ducts 22, 23 are radially spaced from each other with respect to the axis of rotation of the impeller 21 of the electric auxiliary pump 20. The inlet area of the suction duct 23 is adapted in diameter to the suction nozzle 24 of the electric auxiliary pump 20 and is larger than the remaining area of the suction duct 23. The suction duct 23 is connected to the rear area of the impeller 5 of the coolant pump 1 (impeller side chamber) via a tube 25. The tube 25 separates the suction area of the auxiliary pump 20 from the pressure area and extends through an opening 26 in the circular disk 10 of the annular slider 9, into which the tube 25 is pressed. The opening 26 is adjacent to the outer cylinder 12 and therefore in an area at the rear of the impeller 5 where the pressure is particularly high. The inlet pressure of the auxiliary pump 20 is therefore approximately as high as the pump delivery pressure of the coolant pump 1. The tube 25 can include a coarse filter, for example, to prevent chips from the coolant from entering the electric auxiliary pump. Furthermore, the tube 25 prevents the annular slider 9 from turning due to the flow forces acting in the circumferential direction. The speed of the auxiliary pump 20 can be controlled electronically. Increasing the speed of the auxiliary pump increases the pressure in the outlet. The auxiliary pump 20 always rotates in the same direction. The pressure output of the auxiliary pump is directed via the pressure channel 22 to the rear wall of the annular slider 9 and acts primarily against the spring return force of the spring 15 in the closing direction.

The pressure difference between the inlet pressure and the pressure outlet may be a maximum of about 0.5 bar, in particular, a maximum of about 0.3 bar, for example. The discharge pressure of the mechanical auxiliary pump does not significantly influence the balance of forces of the annular slider 9. Due to the large hydraulically effective area A1 of the annular slider 9, even small increases in pressure of the auxiliary pump 20 result in large displacement forces. As a centrifugal pump, the auxiliary pump 20 is able to compensate for leakage losses through drain throttles provided in the hydraulic chamber.

A displacement sensor with target 27 can optionally be attached to the annular slider 9 to detect the position of the annular slider 9 as feedback for a control circuit of the auxiliary pump 20.

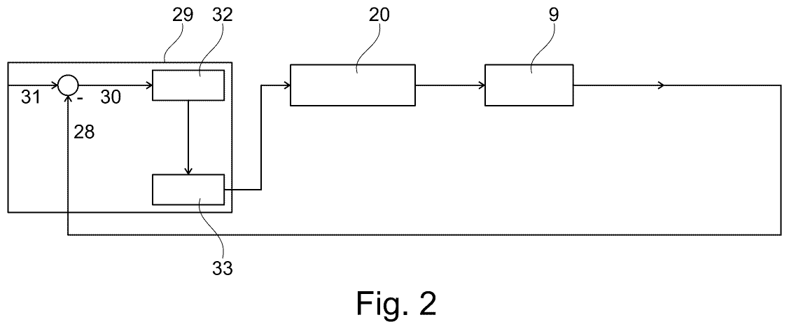

FIG. 2 describes temperature control performed by the controllable coolant pump 1.

As described above, the annular slider is moved by hydraulic pressure, which is used by the auxiliary pump. The arrangement of the spring is such that the annular slider is in the open position when no pressure is exerted on the annular slider by the auxiliary pump. The annular slider can be moved against the spring force of the compression spring by applying pressure to the annular slider surface via the auxiliary pump in the manner of a piston, thus allowing the delivery rate of the coolant pump to be steplessly adjusted.

The current coolant temperature 28 is monitored by a temperature sensor on the hot side of the combustion engine. The engine control 29 of the auxiliary pump calculates a temperature difference 30 between the actual temperature 28 and a target temperature 31, which serves as an input signal for a Proportional Integral Differential (PID) controller 32. The performance map-controlled PID controller 32 transmits an output signal to a pulse width modulation processor 33. The pulse width modulation processor 33 generates a control signal for the auxiliary pump 20 via pulse width modulation. The control current is in a range up to 1 A. Pulse width modulation can be used to vary the pulse width of the slide strokes of the annular slider 9 and the annular slider opening times at a constant pulse frequency by varying the pulse width in such a way that active stepless control of the coolant flow rate is possible, so that the coolant flow rate can be continuously controlled depending on the current demand, on the one hand to ensure gradual optimum heating of the combustion engine, and at the same time, to influence the engine temperature in continuous operation after the combustion engine has heated up in such a way that pollutant emissions, friction losses and fuel consumption can be significantly reduced over the entire operating range of the combustion engine.

Optionally, the temperature control can also be load-dependent via the engine controller. For this purpose, a multi-dimensional performance map is stored for the volume flow as a function of the pump speed, the thermostat opening, the annular slider position and the coolant temperature. The annular slider position is included here as a feedback variable.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A controllable coolant pump comprising:
a pump housing;
an impeller;
a pump shaft rotatably mounted in the pump housing and on free ends of which a belt pulley on one side and the impeller on an opposite side are arranged in a rotationally fixed manner;
an annular slider in a pump chamber and biased by a compression spring to control an outflow region of the impeller of the coolant pump; and
an electric auxiliary pump to draw coolant from an impeller side chamber and deliver the coolant with increased pressure to a side of the annular slider facing away from the impeller in such a way that the annular slider is displaceable against a force of the compression spring.

2. The controllable coolant pump according to claim 1, wherein a hydraulically effective surface of the annular slider is configured such that a pressure difference of at most about 0.6 bar is sufficient to move the annular slider.

3. The controllable coolant pump according to claim 1, wherein the annular slider includes an outer cylinder and a circular disc, the circular disc including an opening through which the coolant passes to a suction connection of the auxiliary pump.

4. The controllable coolant pump according to claim 3, wherein the opening directly adjoins the outer cylinder in the radial direction.

5. The controllable coolant pump according to claim 3, wherein a tube is pressed into the opening, which separates an inlet of the auxiliary pump from a pressure area.

6. The controllable coolant pump according to claim 1, wherein the annual slider is configured to be guided during an axial movement on a guide sleeve inside of the pump, and the compression spring is supported on the guide sleeve.

7. The controllable coolant pump according to claim 1, wherein the auxiliary pump is a centrifugal pump with an uncovered impeller, and a suction channel and a pressure channel of the auxiliary pump are located in the pump housing.

8. The controllable coolant pump according to claim 7, wherein an axis of rotation of the impeller of the auxiliary pump is perpendicular or substantially perpendicular to an axis of rotation of the pump shaft.

9. A commercial vehicle comprising:
a combustion engine;
a cooling circuit to cool the combustion engine; and
at least one controllable coolant pump according to claim 1 to transport coolant present in the cooling circuit, the at least one controllable coolant pump being drivable by a crankshaft of the combustion engine via a belt drive.

10. A method for operating the controllable coolant pump according to claim 1, the method comprising:
measuring an actual temperature in the cooling circuit and determining a temperature difference between the actual temperature and a target temperature;
calculating a control current for the auxiliary pump via a proportional integral differential controller and pulse width modulation; and
controlling the auxiliary pump with the control current.
